(19) United States
(12) Patent Application Publication
(10) Pub. No.: US 2005/0106753 A1
(43) Pub. Date: May 19, 2005

(54) Sanitary fluid collection, application and storage device and methods of use of same

(75) Inventors: Yuchang Wu, Hangzhou (CN); Fei Gao, Hangzhou (CN); Huiyan Guo, San Diego, CA (US)

Correspondence Address: AZURE INSTITUTE;INTELLECTUAL PROPERTY DEPT., 4108 SORRENTO VALLEY BOULEVARD, SAN DIEGO, CA, 92124, US

(73) Assignee: Oakville Trading Hong Kong Limited

(21) Appl. No.: 10/890,540

(22) Filed: Jul. 12, 2004

Related U.S. Application Data
(60) Provisional application No. 60/486,373, filed on Jul. 11, 2003.

(51) Int. Cl. G01N 1/10

(52) U.S. Cl. 436/180; 422/102

(57) ABSTRACT

The present disclosure includes but is not limited to a device for collecting samples, especially liquid samples to be tested for the presence of an analyte, especially for drugs of abuse, antibodies, antigens and biological moieties such as steroids and glucose. In particular, the disclosure describes improvements in collection device design that provide a simple, non-invasive, non-hazardous method of collecting samples from a subject or patient, especially liquid samples such as saliva, oral fluid and urine. The collected sample can be stored in the disclosed device and the device can be used to apply, in a drop-wise manner, an aliquot of the sample directly to a test device.

### CROSS-REFERENCE TO A RELATED APPLICATION

This application claims priority of previously filed U.S. Provisional Patent Application Ser. 60/486,373 filed Jul. 11, 2003. The disclosure of the provisional application is incorporated herein by reference.

### BACKGROUND

The disclosure relates generally to the field of collecting samples, especially liquid samples to be tested for the presence of an analyte, especially for drugs of abuse, antibodies, antigens and biological moieties such as steroids and glucose. In particular, the disclosure relates to improvements in collection device design that provide a simple, non-invasive, non-hazardous method of collecting samples from a subject or patient, especially liquid samples such as saliva, oral fluid and urine.

### SUMMARY

As a non-limiting introduction to the breath of the present disclosure, the present disclosure includes several general and useful aspects, including:
A device, for collecting, storing and applying a sample fluid to a test device, comprising a sample collector having an absorbent member, configured to collect a liquid sample; a sample container, wherein a portion of said container is flexible; an assembly fluidly configured to expel the expressed sample from the device; and a cap. The container of the device has flexible sides such that the sides of the container can be manually pressed inward, whereby, when the device is in the inverted position, pressure, applied manually to the container sides, causes expression of a portion of the sample from the assembly.
A method of collecting a fluid sample, using the device of the present invention, comprising providing the fluid sample; contacting the fluid sample with the sample collector; inserting the sample collector into the container; and closing the container.
A method of applying a fluid sample to a test device, using the device of the present invention, comprising uncapping the device, inverting the device over the sample application zone of a test car or cassette, squeezing the sides of the container of the device and thereby applying an aliquot of the sample to the sample application zone of the test card or cassette.
A kit, comprising at least one device of the present invention, packaged together with instructions for use of said device and optionally a test device.

The present disclosure includes a variety of other useful aspects, which are detailed herein. These aspects of the disclosure can be achieved by using the articles of manufacture and compositions of matter described herein. To gain a full appreciation of the scope of the present disclosure, it will be further recognized that various aspects of the present devices and methods can be combined to make desirable embodiments. In addition, a variety of other aspects and embodiments of the present disclosure are described herein.

### BRIEF DESCRIPTION OF THE DRAWINGS

The foregoing summary, as well as the following detailed description may be better understood when read in conjunction with the accompanying drawings, which are incorporated in and form a part of the specification. The drawings serve to explain the principles of the invention and illustrate embodiments of the present invention that are preferred at the time the application was filed. It should be understood, however, that the invention is not limited to the precise arrangements and instrumentalities shown.

In the drawings:

FIG. 1 depicts one embodiment of the present invention, in the closed position.

FIG. 2 is a cross-sectional view of the device shown in FIG. 1, illustrating the internal structure of this embodiment of the present invention.

FIG. 3 is an exploded view of this embodiment of the present invention, illustrating the various parts of this embodiment and how the parts fit together.

FIG. 4 illustrates the dropper assembly 210 and absorbent member 280, of the device shown in FIG. 1, in the configuration that they would be used to collect a sample.

FIG. 5 illustrates the insertion of a collected sample into the bulb 120 of the device shown in FIG. 1.

FIG. 6 is a cartoon depicting the removal of the cap 110 from the dropper assembly 210, of the device shown in FIG. 1.

FIG. 7 is a cartoon depicting application of an aliquot of the sample 710 to a test device 700.

FIG. 8 illustrates re-capping the device, of FIG. 1, and sealing the cap 110 with evidence tape 800.

### DETAILED DESCRIPTION

Definitions

Unless defined otherwise, all technical and scientific terms used herein have the same meaning as commonly understood by one of ordinary skill in the art. Generally, the nomenclature used herein and the manufacture or laboratory procedures described below are well known and commonly employed in the art. Conventional methods are used for these procedures, such as those provided in the art and various general references. Terms of orientation such as “up” and “down” or “upper” or “lower” and the like refer to orientation of the parts during use of the device. Where a term is provided in the singular, the inventors also contemplate the plural of that term. The nomenclature used herein and the laboratory procedures described below are those well known and commonly employed in the art. As employed throughout the disclosure, the following terms, unless other wise indicated, shall be understood to have the following meanings:

“Assaying” denotes testing for or detecting the presence of a substance or material, such as, but not limited to, a chemical, an organic compound, an inorganic compound, a metabolic product, a drug or a drug metabolite, an organism or a metabolite of such an organism, a nucleic acid, a protein, or a combination thereof. Optionally, assaying denotes measuring the amount of the substance or material. Assaying further denotes an immunological test, a chemical test, an enzymatic test, and the like.

An “analysis device” or “assay device” is a device for analyzing a sample or specimen. An analysis device can be used to detect the presence and/or concentration of an analyte in a sample or specimen, or to determine the presence and/or numbers of one or more components of a sample or specimen, or to make a qualitative assessment of a sample or specimen. Analysis devices of the present disclosure include but are not limited to lateral flow detection devices such as assay strip devices, and columns.

“Analyte” is the compound or composition to be measured that is capable of binding specifically to a ligand, receptor, or enzyme, usually an antibody or antigen such as a protein or drug, or a metabolite, the precise nature of antigenic and drug analytes together with numerous examples thereof are disclosed in U.S. Pat. No. 4,299,916 and U.S. Pat. No. 4,275,149. Analytes can include antibodies and receptors, including active fragments or fragments thereof. An analyte can include an analyte analogue, which is a derivative of an analyte, such as, for example, an analyte altered by chemical or biological methods, such as by the action of reactive chemicals, such as adulterants or enzymatic activity. An analyte may be a drug or drug metabolite, especially, but not limited to drugs of abuse, such as, for example amphetamines (speed), cocaine, THC (cannabis/pot), opiates (heroine), phencyclidine (PCP), methadone, benzodiazepines, methamphetamines (MDMA/ecstasy), phencyclidine (PCP/angle dust), tricyclic antidepressants and barbiturates.

“Sample” or “specimen” may be used interchangeably. “Sample” or “specimen” denotes any material to be assayed for the presence and/or concentration of an analyte in a sample or specimen, or to determine the presence and/or numbers of one or more components of a sample or specimen, or to make a qualitative assessment of a sample or specimen. A sample can be the same as a specimen. Preferably, a sample is a fluid sample, preferably a liquid sample. Examples of liquid samples that may be assayed using an assay device of the present disclosure include bodily fluids including blood, serum, plasma, saliva, urine, ocular fluid, semen, and spinal fluid; water samples, such as samples of water from oceans, seas, lakes, rivers, and the like, or samples from home, municipal, or industrial water sources, runoff water or sewage samples; and food samples, such as milk or wine. Viscous liquid, semi-solid, or solid specimens may be used to create liquid solutions, eluates, suspensions, or extracts that can be samples. For example, throat or genital swabs may be suspended in a liquid solution to make a sample. Samples can include a combination of liquids, solids, gasses, or any combination thereof, as, for example a suspension of cells in a buffer or solution. Samples can comprise biological materials, such as cells, microbes, organelles, and biochemical complexes. Liquid samples can be made from solid, semisolid or highly viscous materials, such as soils, fecal matter, tissues, organs or other samples that are not fluid in nature. For example, these solid or semi-solid samples can be mixed with an appropriate solution, such as a buffer, such as a diluent or extraction buffer. The sample can be macerated, frozen and thawed, or otherwise extracted to form a fluid sample. Residual particulates can be removed or reduced using conventional methods, such as filtration or centrifugation.

Other technical terms used herein have their ordinary meaning in the art that they are used, as exemplified by a variety of technical dictionaries.

Sample Collection, Application and Storage Device

There are many problems associated with collecting and using biological samples, especially samples from people. For example, the samples pose a biohazard, may be difficult to work with, or simply offensive. It may be difficult to collect a sample from a subject, while the act of sample collection poses another biohazard risk to the technician collecting the sample. In certain instances, samples may need to be collected from unwilling subjects who may resist the sample collection. In addition, certain settings, such as law enforcement, sample collection poses additional safety, storage and convenience problems. Because of the above problems, some industries, such as, for example, the drug of abuse testing industry, are turning away from samples, such as urine, to saliva and oral fluids. The present invention seeks to remedy the afore mentioned problems and satisfy the afore mentioned long felt needs. The present invention provides a convenient, simple and sanitary method of collecting a liquid sample, especially a viscous sample, such as saliva or oral fluid. The collected fluid can be stored for later use or used immediately for assaying for an analyte of interest. In addition, the unused portion of the sample that remains in the container may be sent to a confirmation laboratory, to confirm the results of the assay conducted by the technician.

These embodiments of the invention, as well as others described herein, can be achieved by using the methods, articles of manufacture and compositions of matter described herein. To gain a full appreciation of the scope of the present invention, it will be further recognized that various embodiments of the present invention can be combined to make additional desirable embodiments of the invention.

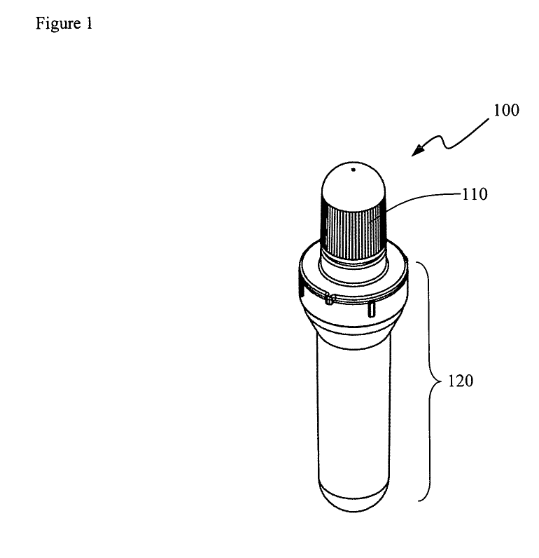

Referring now to the figures, FIG. 1 illustrates one embodiment of the present device, a device 100 for collecting, storing and applying a liquid sample, such as, but not limited to, urine or blood. FIG. 1 illustrates the exterior of the device in an unopened state, showing a cap 110 and a container 120.

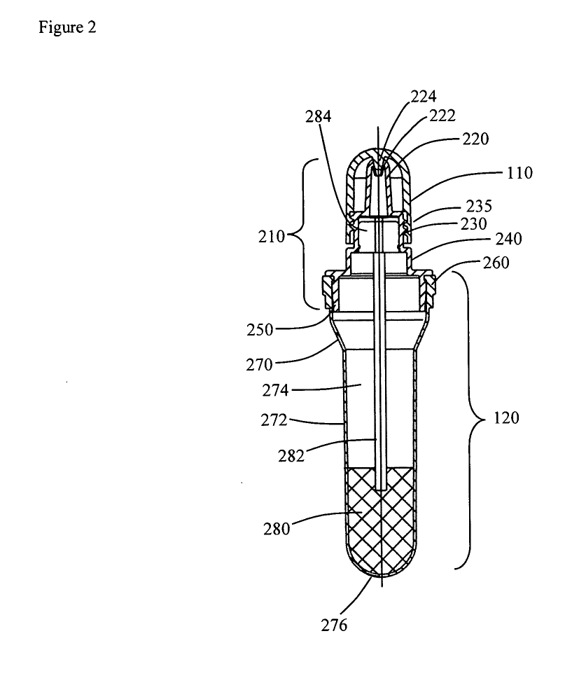

FIG. 2 is a cross-section of the present device 100, having a dropper assembly 210, a cap 110 and a container 120. The dropper assembly 210 further comprises a dropper nipple 220, having a dropper orifice 222, through which sample can be expelled from the present device 100. The dropper assembly 210 further comprises a neck 240 and a skirt 250. At least the dropper nipple 220 and a portion of the neck 240 are covered by the cap 110. The cap 110 may have a dropper stopper 224 adapted to seal the dropper orifice 222. Optionally, the neck 240 of the dropper assembly 210 may have threads 230, which rotatably mate with cap threads 235 inside the cap 110 and thereby seal the dropper assembly 210. Alternatively, the cap 110 may close the dropper assembly 210 with a snap-fit seal, or any other convenient method known in the art. Optionally, the cap 110 may be tethered to the dropper assembly 210 by a cord or hinge, or other well known means.

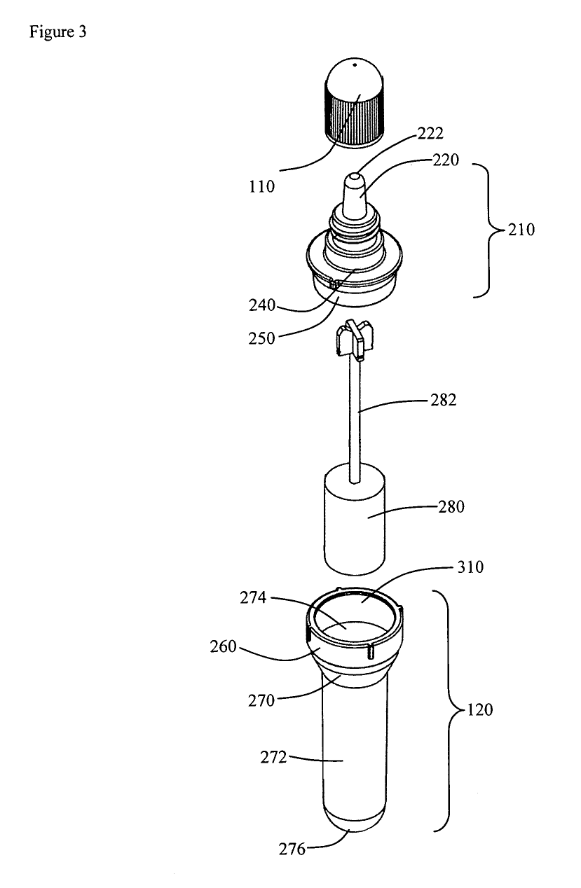

Referring to FIG. 2 and FIG. 3, the container 120 of the present device 100 further comprises as lip 260, defining a mouth 310, and optional shoulder 270, a flexible side wall 272 and a bottom 276. The lip 260 and optional shoulder 270 of the container 120 are adapted to be substantially rigid. However, the side wall 272 of the container 120 must be flexible, so as to allow the sides of the container 120 of the present device 100 to be pressed inward by the application of pressure, preferably manual pressure. The side walls 272 of the container 120 may be of any convenient shape known in the art commonly used for dropper squeeze bulbs, such as bulbous, cylindrical, lobular, spherical, pear-shaped, tear-drop or box-shaped.

Applying pressure to the side wall 272 of the container 120 causes a liquid sample contained in the present device 100 to be expressed through the orifice 222 of the dropper assembly 210. The dropper assembly 210, especially the dropper nipple 220 and dropper orifice 222, may be configured to expel the liquid sample as a stream, drops, droplets, a mist, or the like.

Still referring to FIGS. 2 and 3, the dropper assembly 210 further comprises a skirt 250 that attaches to the lip 260 and seals the mouth 310 of the container 120. The dropper assembly 210 may seal the container 120 by screwing onto or snapping onto the lip 260 of the container 120, or by any other convenient means. In certain aspects of the present device 100, the dropper assembly 210 may be tethered to the container 120 by a string or plastic strip or hinge member.

The lip 260, optional shoulder 270, side wall 272 and bottom 276 of the container 120 define the lumen 274 of the container 120 of the present device 100. The lumen 274 is adapted to receive an absorbent member 280, for collecting the liquid sample, which will be discussed in more detail below.

Optionally, the interior surfaces of the container 120 and dropper assembly 210 may be treated to reduce sample components binding or sticking to them. A variety of treatments are known and used in the art, depending upon the type of sample collected and the analytes of interest.

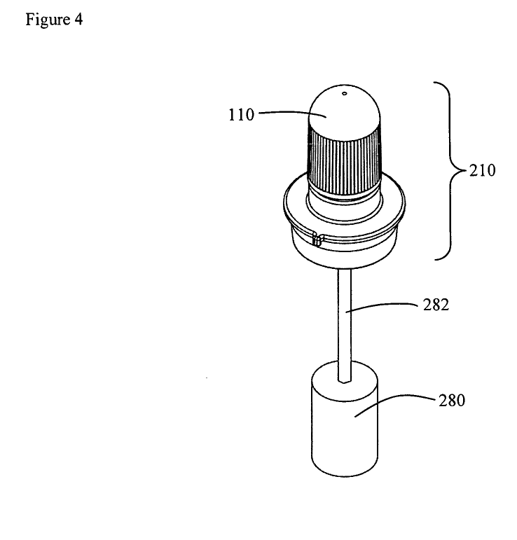

As shown in FIGS. 3-4, the absorbent member 280 is attached to one end of a support member 282, such as a wood or plastic stick and is configured to collect a liquid sample. In this regard, the absorbent member 280 can comprise any type of material that can absorb a liquid sample, such as a foam or a sponge. It should be appreciated that the size and shape of the support member 282 can vary, as long as the support member 282 is adapted to fit, along with the absorbent member 280, into the interior of the present device 100 without blocking the expression of sample through the dropper orifice 222. Optionally, the absorbent member 280 can be soaked in a solution designed to stimulate salivation by a subject providing a sample of saliva.

At the second end of the support member 282 is one or more flanges 284, which may be of various shapes. The flanges 284 are adapted to fit into the neck 240 of the dropper assembly 210 and to provide space, around the second end of the support member 282, though which the sample can flow, such that the orifice 222 of the dropper assembly is fluidly connected to the lumen 274 of the container 120. In certain aspects of the present device 100, the flanges 284 are adapted to hold the support member 282 firmly or snuggly in the neck 240 of the dropper assembly 210, such that the entire dropper assembly 210 can act as a handle for the absorbent member 280. In other aspects of the present device 100, the flanges 284 may be adapted to be easily removed from the dropper assembly 210, such that the support member 282 can be used as a handle for manipulating the absorbent member 280.

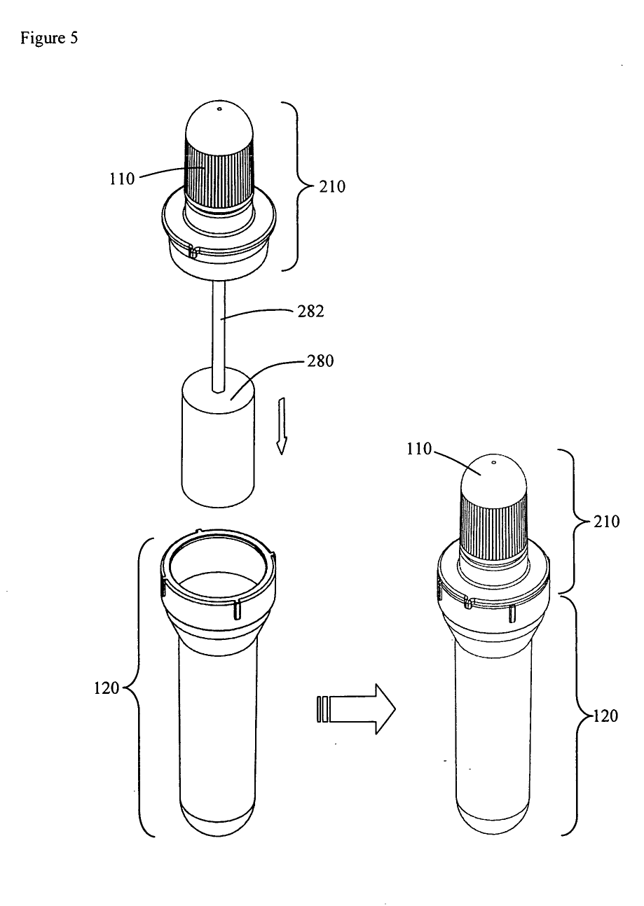

FIG. 5 illustrates one step of the use of the present device 100, that of inserting the absorbent member 280 into the lumen 274 of the container 120 and sealing the mouth 310 of the container 120 with the dropper assembly 210. In this particular example, the dropper assembly 210 has a skirt 250, which snaps snuggly into the mouth 310 of the container 120. In certain embodiments of the present device 100, the dropper assembly 210, remounted on the container 120, is adapted to seal the mouth 310 of the container 120 such that the dropper assembly 210 cannot be removed again or so that tampering with the device 100 can be detected.

Alternative methods of closing the mouth 310 of the container 120 are also contemplated by the inventors. For example, the skirt 250 of the dropper assembly 210 and the lip 260 of the container 120 may have mating threads by which the present device 100 may be screwed closed. Prior to the step of returning the absorbent member 280 to the interior of the container 120, the absorbent member 280 is used to collect a liquid sample. For example, the absorbent member 280 is placed in a subject's mouth, until saturated with saliva. In another example, the absorbent member 280 is soaked in collected urine, or even held in the urine stream of a donor or patient.

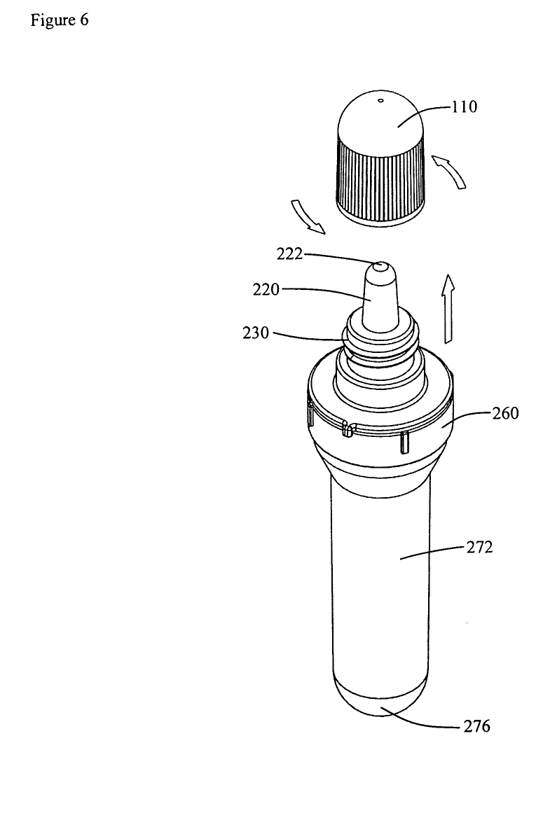

FIG. 6 illustrates removing the cap 110 from the dropper assembly 210. In this particular example, the cap 110 is removed by un-screwing. The cap 110 may be attached to the dropper assembly by other convenient methods, such as snapping onto the neck 240 of the dropper assembly 210.

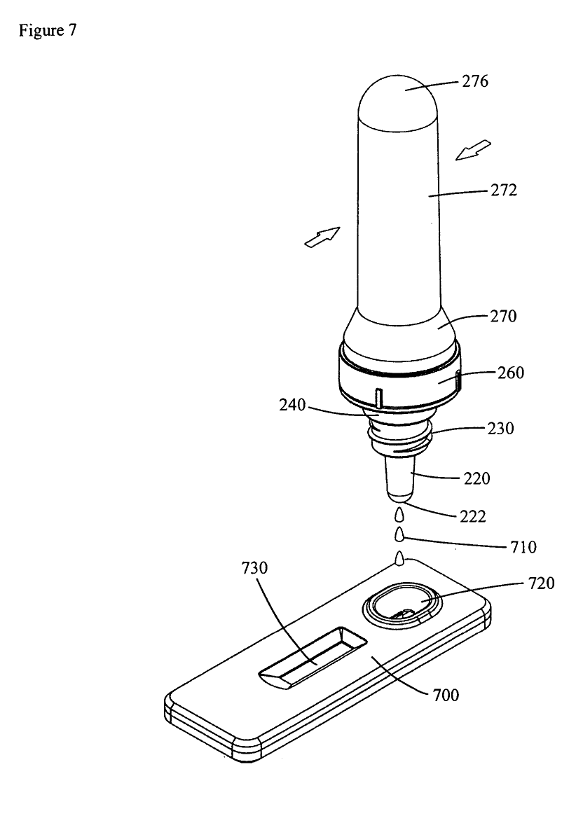

FIG. 7 illustrates another embodiment of the present device 100, showing one way that an aliquot of a collected sample can be expressed from the dropper assembly 210. Preferably, the absorbent member 280 is left inside the lumen 274 of the container 120. With the dropper assembly 210 in place, sealing the mouth 310 of the container 120, the un-capped device is inverted and the side walls 272 of the container are squeezed. This causes a portion of the collected sample to be expressed from the absorbent member 280. Subsequently, the expressed sample flows into the dropper assembly 210, thought the dropper nipple 220 and out the dropper orifice 222 (see 710). In certain embodiments, the expressed sample flows out of the orifice 222 in a drop-wise manner. However, the dropper assembly 210 can be adapted for the sample to be expelled from the orifice 222 as a stream, droplets, mist or the like.

As illustrated in FIG. 7, the present device 100 may be used to apply an aliquot of sample 710 to the application area or well 720 of a test device 700. After incubation of the test device 700, the test results might be observed in a results zone 730. A variety of test devices, commonly used today, could be used in conjunction with the present device 100. For example, rapid immunoassays or chemical assays, which test for the presence of an analyte and are increasingly used in clinics, doctor's offices, law enforcement settings and employment settings, might be used. A variety of analytes could be tested for, in the sample collected with the present device 100. For example, a sample, collected with the present device 100, might be tested for drugs of abuse, metabolites, etiological agents or the like.

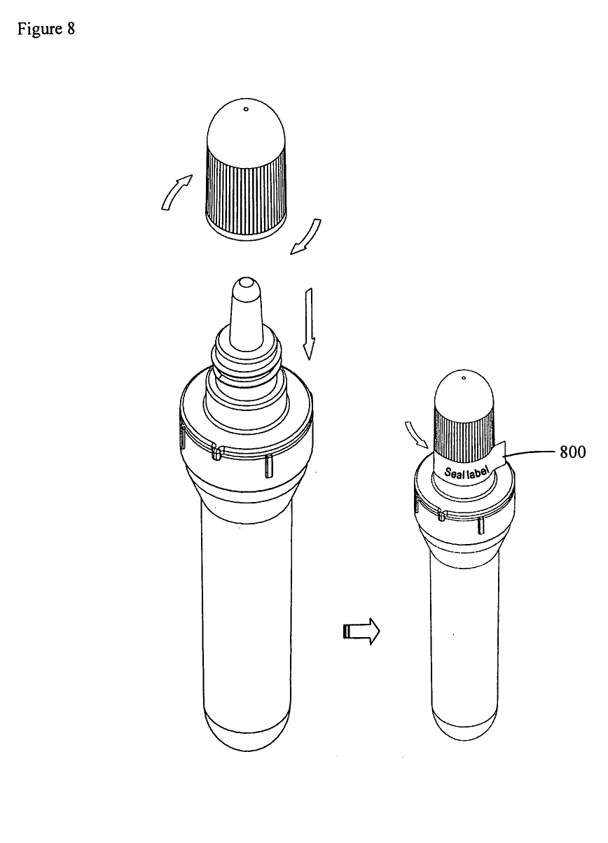

FIG. 8 illustrates the final step of using the present device 100. After expressing an aliquot of sample 710, the device 110 is returned to the up-right position and re-capped. The cap 110 is then sealed with evidentiary tape 800, to prevent tampering with the sample.

Specimen

Any type of liquid specimen may be used with the present device, including liquid specimens of the nature and character as described above in the definition portion of this disclosure. Alternatively, the sample applied to the test strip of the present device may be derived from other types of specimens dissolved in an appropriate liquid, such as a buffer or water. For example, the specimen may be composed of fine powdery materials such as talc, carbon black, pharmaceutical preparations, or gases such as argon or methane. Additional specimens can include atmospheric specimens that can be assayed for particulates or radioactive isotopes such as radon.

In an alternative embodiment of the present device the specimen to be tested is a biological specimen. Such biological specimens include but are not limited to a sample from a subject such as an animal or a human. A sample from a subject can be of any appropriate type, such as a sample of fluid, tissue, organ or a combination thereof. The biological specimen can also be a sample of other biological material, such as plants, bacteria, cell or tissue cultures, viruses and prions, or food, including food such as material derived from plants or animals or combinations thereof. The sample can be processed prior to introduction into the assay device. In the alternative, a sample and reagent can be combined within a specimen collection container. Such reagents can be used to process a sample, such as digesting solid samples with appropriate reagents such as chemicals, such as acids or bases, or with enzymes such as proteases. Other reagents can be used to extract analytes from a sample, such as extraction of antigens from biological entities, such as antigens from etiological agents such as bacteria, parasites, viruses or prions such as known in the art.

The sample collected by the present device 100 is any material to be assayed for the presence and/or concentration of an analyte in a sample or specimen that can be absorbed by the absorbent member 280. Preferably, the sample is a fluid sample, preferably a liquid sample. Examples of liquid samples that may be collected using a device of the present invention include bodily fluids including blood, serum, plasma, saliva, urine, ocular fluid, semen, and spinal fluid; water samples, such as samples of water from oceans, seas, lakes, rivers, and the like, or samples from home, municipal, or industrial water sources, runoff water or sewage samples; and food samples, such as milk or wine. Viscous liquid, semi-solid, or solid specimens may be used to create liquid solutions, eluates, suspensions, or extracts that can be samples. For example, throat or genital swabs may be suspended in a liquid solution to make a sample. Samples can include a combination of liquids, solids, gasses, or any combination thereof, as, for example a suspension of cells in a buffer or solution.

Samples can comprise biological materials, such as cells, microbes, organelles, and biochemical complexes. Liquid samples can be made from solid, semisolid or highly viscous materials, such as soils, fecal matter, tissues, organs, biological fluids or other samples that are not fluid in nature. For example, these solid or semi-solid samples can be mixed with an appropriate solution, such as a buffer, such as a diluent or extraction buffer. The sample can be macerated, frozen and thawed, or otherwise extracted to form a fluid sample. Residual particulates can be removed or reduced using conventional methods, such as filtration or centrifugation.

The present invention is particularly useful for the collection of viscous samples, such as oral fluids and saliva. The absorbent member 280 can be configured to fit comfortably in to the mouth of a subject, such as a human. The absorbent member 280 may additionally be constructed of a sponge or foam designed to be chewed. In one aspect of the present invention, the absorbent member 280 is soaked in a solution to stimulate salivation. When the absorbent member 280 is placed in a subject's mouth, the subject can suck and chew the absorbent member 280 until the absorbent member 280 is filled with sample.

In another setting, the present invention may be used to conveniently collect urine from a subject without the use of a cup. For example, the absorbent member 280 may be held in the urine stream of a pet, such as a dog or cat, or a young child.

Methods of Use

The present disclosure contemplates methods of use of the present device 100 described supra. One embodiment of the present method for collecting a sample comprises the steps of opening the device 110 and placing the absorbent member 280 in a liquid sample. For example, the absorbent member 280 can be placed in a patient's mouth until the absorbent member 280 has become saturated with saliva. Next, the absorbent member 280 is inserted into the lumen 274 of the container 120 until the dropper assembly 210 is mounted on the lip 260 of the container 120. The device and sample there in could be placed in storage or, alternatively, the sample may be tested for the presence of an analyte. To test for the presence of an analyte, an appropriate test device is obtained and placed on the bench top or table. The present device 100, containing the sample, is un-capped and inverted over the sample application zone of the test device. Next, the sides of the container 120 and thus the absorbent member 280 contained within the container 120 is squeezed. The manual pressure on the sides of the container 120 expresses some of the collected sample from the absorbent member 280. The expressed sample flow through the flanges 284, the dropper neck 240 and the dropper nipple 220, and out through the dropper orifice 222. The sample is expelled from the dropper orifice 222 into the sample application zone of the test device. After application of the sample, the present device 100 is returned to the up-right position and re-capped. The cap 110 is preferably sealed onto the dropper assembly with evidence tape 800. The present device 100 and the sample contained therein are now ready for storage or to be shipped to another site for additional tests.

Kits

Another embodiment of the present device 100 is a kit, for collecting a liquid sample, packaged together with instructions for use. In certain embodiments of the present device 100, the device 100 may be packaged together with instructions and testing device for the presence of an analyte, such as drugs of abuse or metabolites.

Examples of Use

Drug Testing Prior to Employment

A manufacturing company has conditionally hired a new engineer. Prior to the first day of work, the engineer goes to a drug testing laboratory, where he is tested for illegal drugs. At the drug testing laboratory, the engineer chews the absorbent member of the present invention and thus produces a saliva sample for the technician. The engineer then leaves the facility. The technician replaces the absorbent member back into the container of the device. She then obtains a drug of abuse test cassette and places it on the bench top. Next, the technician removes the cap from the device of the present invention, inverts the device and applies (by squeezing the sides of the bulb) three drops of the engineer's donated saliva into each sample application well of the test cassette. She sets a timer for five minutes and allows the test device to incubate on the bench top. At the conclusion of the incubation, the technician reads and records the test and control (positive and negative) results for each drug assayed. When she is finished, the technician seals the cap onto the device with evidence tape and sends the device, with the contained saliva, to a confirmation testing laboratory.

Pet Dog Urine Analysis for Bladder Infection:

A pet owner takes her dog to the vet because the house-trained dog is urinating an excessive number of times and in the house. The veterinarian suspects that the dog may have a bladder infection. To determine if this is true, the vet takes the dog outside. When the dog urinates, the vet holds the absorbent member of the present invention in the urine stream. The vet inserts the absorbent member into the bulb of the device. To test for a blabber infection, the vet expels a few drops of the urine onto pH paper, which indicates that the dog's urine is in the alkaline range found in dogs with bladder infections. To confirm his findings, the vet expresses a drop of urine onto a slide and examines the urine under a microscope. The vet observes white blood cells in the urine, confirming that the dog has a bladder infection. The vet prescribes a course of antibiotics for the dog, which subsequently recovers from the bladder infection.

1. A device, for collecting fluids, storing and applying the fluid to a test device, comprising:
a. a sample collector having an absorbent member, configured to collect a liquid sample;
b. a sample container, wherein a portion of said container is flexible;
c. an assembly fluidly configured to expel the expressed sample from the device; and
d. a cap.

2. The device of claim 1, wherein said sample collector further comprises a support member and a flange, wherein said absorbent member is attached to said support member.

3. The device of claim 2, wherein said absorbent member further comprises a foam.

4. The device of claim 2, wherein said absorbent member further comprises a sponge.

5. The device of claim 2, wherein said absorbent member is treated with a solution that stimulates salivation in a subject from which the sample is to be collected.

6. The device of claim 2, wherein said support member is substantially rigid and optionally attaches to said assembly.

7. The device of claim 1, said assembly being removably attached to the exterior surface of said first end of said barrel by a hinge member.

8. The device of claim 1, said container further comprising a barrel having first and second ends and an exterior and an interior, said first end further comprising an orifice providing access to said interior of said barrel for receiving said absorbent member.

9. The device of claim 1, said container having flexible sides such that the sides of said container can be manually pressed inward, whereby, when said device is in the inverted position, manually applied pressure on the container sides causes expression of a portion of the sample from said assembly.

10. The device of claim 1, wherein said container is shaped like a squeeze bulb.

11. The device of claim 1, wherein said container is cylindrically, lobularly, spherically, pear, tear-drop or box-like shaped.

12. The device of claim 1, wherein said assembly is configured to expel liquid as a stream, drops, droplets, a mist, or the like.

13. The device of claim 1, said assembly further comprising: a lid having a dropper tip, said dropper tip having a mouth.

14. The device of claim 13, wherein said lid is adapted to tightly seal the first end of said barrel.

15. The device of claim 8, the bottom of said assembly being shaped so as to be snapably attachable to said first end of said barrel and thereby close said container.

16. The device of claim 8, said first end of said barrel having first threads.

17. The device of claim 16, said assembly having second threads shaped to thread with said first threads of said barrel.

18. The device of claim 1, wherein said container is adapted to allow for squeezing and when the device of claim 1 is in an inverted position said squeezing of said container causes drops of the sample to be expelled from the device of claim 1 through said orifice of said dropper tip.

19. The test device of claim 1, wherein said sample is a biological sample.

20. The test device of claim 1, wherein said sample is a liquid or a solution comprising a biological sample.

21. The test device of claim 1, wherein said sample is selected from the group consisting of blood, plasma, saliva, oral fluid, cerebrospinal fluid, urine, fecal material, mucous, vaginal or oral swabs, semen, tissue, fluid or puss exudates, aspirates, cell culture, conditioned media from a cell culture, homogenized cell culture, homogenized tissue and solutions derived from solid or semi-solid biological samples.

22. The test device of claim 1, wherein said analyte of interest is selected from the group consisting of drugs, drugs of abuse, alcohol, poisons, bacteria, viruses, proteins, sugars, carbohydrates, lectins, fats, antibodies, receptors, hormones, etiological agents and biological metabolites.

23. A device for collecting and storing a fluid, and applying an aliquot of the fluid to a test device, comprising: a sample collector having a foam or sponge absorbent member, configured to collect a liquid sample; a container having flexible sides and that receives the sample collector; and assembly fluidly connected to the container and configured to expel a portion of the sample from the device.

24. The device of claim 23, wherein said absorbent member is treated with a solution that stimulates salivation in a subject from which the sample is to be collected.

25. The device of claim 23, said container further comprising a barrel having first and second ends and an exterior and an interior, said first end further comprising an orifice providing access to said interior of said barrel for receiving said sample.

26. The device of claim 23, said container having flexible sides such that the sides of said container can be manually pressed inward, whereby, when said device is in the inverted position, manually applied pressure on the container causes expression of the sample from said assembly.

27. The device of claim 23, wherein said container is shaped like a squeeze bulb.

28. The device of claim 23, wherein said container is cylindrically, lobularly, spherically, pear, tear-drop or box-like shaped.

29. The device of claim 23, wherein said assembly is configured to expel liquid as a stream, drops, droplets, a mist, or the like.

30. The device of claim 23, said assembly being removably attached to the exterior surface of said first end of said barrel by a hinge member.

31. The device of claim 23, said assembly further comprising: a lid having a dropper tip, said dropper tip having a mouth.

32. The device of claim 23, the bottom of said assembly being shaped so as to be snapably attachable to said container and thereby close said container.

33. The device of claim 25, said first end of said barrel having first threads.

34. The device of claim 25, said assembly having second threads shaped to thread with said first threads of said barrel.

35. The device of claim 25, wherein said assembly is adapted to tightly seal the first end of said barrel.

36. The device of claim 23 wherein said container is adapted to allow for squeezing and when the device of claim 23 is in an inverted position said squeezing of said container causes drops of the sample to be expelled from the device of claim 23 through said orifice of said dropper tip.

37. The test device of claim 23, wherein said sample is a biological sample.

38. The test device of claim 23, wherein said sample is a liquid or a solution comprising a biological sample.

39. The test device of claim 23, wherein said sample is selected from the group consisting of blood, plasma, saliva, oral fluid, cerebrospinal fluid, urine, fecal material, mucous, vaginal or oral swabs, semen, tissue, fluid or puss exudates, aspirates, cell culture, conditioned media from a cell culture, homogenized cell culture, homogenized tissue and solutions derived from solid or semi-solid biological samples.

40. The test device of claim 23, wherein said analyte of interest is selected from the group consisting of drugs, drugs of abuse, alcohol, poisons, bacteria, viruses, proteins, sugars, carbohydrates, lectins, fats, antibodies, receptors, hormones, etiological agents and biological metabolites.

41. A method of collecting a fluid sample, using the device of claim 1 or 23, comprising:
a. providing the fluid sample;
b. contacting the fluid sample with said sample collector;
c. inserting said sample collector into said container; and
d. closing said container.

42. A method of applying a collected fluid sample to a test device, using the device of claim 1 or 23, comprising:
a. inverting the device of claim 1 or claim 23;
b. squeezing said container; and
c. applying drops of the collected fluid sample to a test device.

43. A method of collecting a fluid sample, using the device of claim or claim 23, comprising:
a. providing the fluid sample;
b. contacting the fluid sample with an absorbent sample collector;
c. inserting said absorbent sample collector into a sample container;
d. screwing a top assembly on to said sample container.

44. A method of applying a collected fluid sample to a test device, using the device of claim 1 or claim 23, comprising:
a. removing said cap of the device of claim 1 to expose said dropper assembly;
b. inverting the device of claim 1;
c. squeezing at least one side of said sample container; and
d. applying expressed drops of the collected fluid sample to a test device.

45. A kit, comprising: at least one device of claim 1 or claim 23 packaged together with instructions for use of said device.

46. The kit of claim 45, further comprising a test device.
